(19) United States
(12) Patent Application Publication
(10) Pub. No.: US 2014/0333548 A1
(43) Pub. Date: Nov. 13, 2014

(54) TABLET COMPUTER AND INPUT METHOD THEREOF

(71) Applicant: Wistron Corporation, New Taipei City (TW)

(72) Inventor: Da-Li Peng, New Taipei City (TW)

(73) Assignee: Wistron Corporation, New Taipei City (TW)

(21) Appl. No.: 14/108,412

(22) Filed: Dec. 17, 2013

(30) Foreign Application Priority Data
May 7, 2013 (CN) 201310164819.7

(51) Int. Cl. G06F 3/041

(52) U.S. Cl. CPC G06F 3/041
USPC 345/173

(57) ABSTRACT

A tablet computer and an input method thereof are provided. The tablet computer includes a touch screen, an embedded controller, a processor, and an encoding rule database. The processor detects a touch state of the touch screen through the embedded controller, wherein after determining a corresponding code according to a touch state and an encoding rule, the processor displays the corresponding code on the touch screen. The encoding database stores the encoding rule.

This application claims the benefit of People's Republic of China application Serial No. 201310164819.7, filed May 7, 2013, the subject matter of which is incorporated herein by reference.

### BACKGROUND OF THE INVENTION

1. Field of the Invention

The invention relates in general to a computer, and more particularly to a tablet computer and an input method thereof.

2. Description of the Related Art

The table computer is a kind of compact and portable personal computer, with its touch screen as the basic input device. The touch screen enables the user to input data with one's fingers, instead of using the conventional keyboard or mouse. The tablet computer, as data input is needed, displays an input box on the touch screen for the user to select. After the user selects the input box, the touch screen displays a screen keyboard, which shows a number of keys corresponding to codes (alphabets and/or symbols) with fixed positions. The user needs to touch a key on the screen keyboard so as to input the corresponding code.

However, the screen keyboard occupies a large portion of the display region, causing the touch screen not be utilized sufficiently. In addition, since every key on the screen keyboard has its fixed position, the user is required to make a touch at some fixed position for correctly inputting for a corresponding code. In such way, the efficiency of inputting data would be reduced.

### SUMMARY OF THE INVENTION

The invention is directed to a tablet computer and an input method thereof. In an embodiment, inputting data can be done without the need of displaying a screen keyboard, which can enhance the convenience of usage.

According to an embodiment of the invention, a tablet computer is provided. The tablet computer includes a touch screen, an embedded controller, a processor, and an encoding rule database. The processor detects a touch state of the touch screen through the embedded controller, wherein after determining a corresponding code according to a touch state and an encoding rule, the processor displays the corresponding code on the touch screen. The encoding database stores the encoding rule.

According to another embodiment, an input method for a tablet computer is provided. The input method includes: detecting number of points of long touching and number of tapping on a touch screen of the tablet computer; determining a corresponding code according to the number of points of long touching, the number of tapping, and an encoding rule; and displaying the corresponding code on the touch screen.

According to another embodiment, an input method for a tablet computer is provided. The input method includes: detecting a first trigger position and a second trigger position on a touch screen of the tablet computer. recognizing a first finger type according to the first trigger position, and recognizing a second finger type according to the second trigger position; determining a corresponding code according to the first finger type, the second finger type, and an encoding rule; and displaying the corresponding code on the touch screen.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram illustrating a tablet computer according to a first embodiment.

FIG. 2 is a flowchart illustrating an input method for the tablet computer according to the first embodiment.

FIG. 3 is a block diagram illustrating a tablet computer according to a second embodiment.

FIG. 4 is a flowchart illustrating an input method for the tablet computer according to the first embodiment.

FIG. 5 is a flowchart illustrating an initialization procedure for a tablet computer according to an embodiment.

FIG. 6 illustrates an example of fingers' laid positions on the touch screen.

### DETAILED DESCRIPTION OF THE INVENTION

### First Embodiment

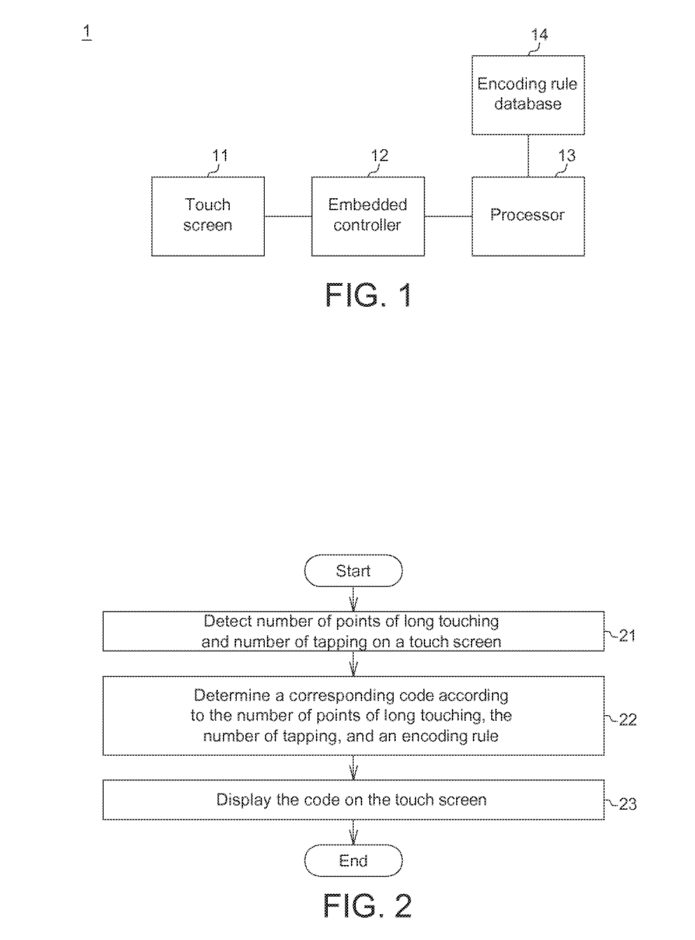

Referring to FIG. 1, a tablet computer 1 is illustrated according to a first embodiment in a block diagram. The tablet computer 1 includes a touch screen 11, an embedded controller 12, a processor 13, and an encoding rule database 14. The embedded controller 12 is coupled to the touch screen 11 and the processor 13, and the processor 13 is coupled to the encoding rule database 14. The encoding database 14 stores an encoding rule which can be, for example, predetermined, or configured or set by the user through the touch screen 11. When the touch screen 11 does not display a screen keyboard, the processor 13 detects a touch state of the touch screen 11 through the embedded controller 12, and the processor 13, after determining a corresponding code according to the touch state and the encoding rule, displays the corresponding code on the touch screen 11.

Referring to FIGS. 1 and 2, FIG. 2 illustrates an input method for the tablet computer according to the first embodiment in a flowchart. The touch state includes, for example, number of points of long touching and number of tapping on the touch screen 11. The input method for the tablet computer 1 includes the following steps. First, in step 21, the number of points of long touching and the number of tapping on the touch screen 11. In step 22, a corresponding code is then determined according to the number of points of long touching, the number of tapping, and an encoding rule. After that, in step 23, the corresponding code is displayed on the touch screen 11. In addition, the user can set up or reconfigure the encoding rule in the encoding rule database 14 so as to meet the custom of the user. In one embodiment, the above step 21 can be performed after the tablet computer 1 enters an input data mode. For example, the tablet computer 1 enters an input data mode for waiting for the user to enter data after the user touches the touch screen 11 to select an input box displayed on the touch screen 11. In addition, the number of points of long touching and the number of tapping on the touch screen 11 are detected after the tablet computer 1 enters the input data mode. Without the need of a screen keyboard displayed on the touch screen 11, the user can input data by way of combinations of the number of points of long touching and the number of tapping, thus enhancing the user's convenience of operation.

Referring to FIG. 1 and Table 1, Table 1 describes an encoding rule for the tablet computer 1, which may be called five-touch-point rule. The encoding rule includes combinations of the number of points of long touching and the number of tapping on the touch screen 11. For example, when the user makes a long touch with a finger on the touch screen 11 and another finger taps the touch screen for 5 times, the processor 13 detects, through the embedded controller 12, that the number of points of long touching and the number of tapping on the touch screen 11 are one and 5, respectively. The processor 13 determines a corresponding code of “j” according to the number of points of long touching, the number of tapping, and the encoding rule described in Table 1. In another example, when the user makes a long touch with two fingers on the touch screen 11 and another finger taps the touch screen for 3 times, the processor 13 detects, through the embedded controller 12, that the number of points of long touching and the number of tapping on the touch screen 11 are 2 and 3, respectively. The processor 13 determines a corresponding code of “m” according to the number of points of long touching, the number of tapping, and the encoding rule described in Table 1.

TABLE 1

| Number of point | Number of | |
|---|---|---|
| of long touching | tapping | Code |
| 0 | 1 | a |
| 0 | 2 | b |
| 0 | 3 | c |
| 0 | 4 | d |
| 0 | 5 | e |
| 1 | 1 | f |
| 1 | 2 | g |
| 1 | 3 | h |
| 1 | 4 | i |
| 1 | 5 | j |
| 2 | 1 | k |
| 2 | 2 | l |
| 2 | 3 | m |
| 2 | 4 | n |
| 2 | 5 | o |
| 3 | 1 | p |
| 3 | 2 | q |
| 3 | 3 | r |
| 3 | 4 | s |
| 3 | 5 | t |
| 4 | 1 | u |
| 4 | 2 | v |
| 4 | 3 | w |
| 4 | 4 | x |
| 4 | 5 | y |
| 5 | 0 | z |

Referring to FIG. 1 and Table 2, Table 2 describes another encoding rule for the tablet computer 1, which may be called ten-touch-point rule. The encoding rule includes combinations of the number of points of long touching and the number of tapping on the touch screen 11. For example, when the user makes a long touch with 6 fingers on the touch screen 11 and another finger taps the touch screen for one time, the processor 13 detects, through the embedded controller 12, that the number of points of long touching and the number of tapping on the touch screen 11 are 6 and one, respectively. The processor 13 determines a corresponding code of “r” according to the number of points of long touching, the number of tapping, and the encoding rule described in Table 2. In another example, when the user makes a long touch with 9 fingers on the touch screen 11 while another finger taps the touch screen for two times, the processor 13 detects, through the embedded controller 12, that the number of points of long touching and the number of tapping on the touch screen 11 are 9 and 2, respectively. The processor 13 determines a corresponding code of “y” according to the number of points of long touching, the number of tapping, and the encoding rule described in Table 2.

TABLE 2

| Number of point | Number of | |
|---|---|---|
| of long touching | tapping | Code |
| 0 | 1 | a |
| 0 | 2 | b |
| 0 | 3 | c |
| 1 | 1 | d |
| 1 | 2 | e |
| 1 | 3 | f |
| 2 | 1 | g |
| 2 | 2 | h |
| 2 | 3 | i |
| 3 | 1 | j |
| 3 | 2 | k |
| 3 | 3 | l |
| 4 | 1 | m |
| 4 | 2 | n |
| 4 | 3 | o |
| 5 | 1 | p |
| 5 | 2 | q |
| 6 | 1 | r |
| 6 | 2 | s |
| 7 | 1 | t |
| 7 | 2 | u |
| 8 | 1 | v |
| 8 | 2 | w |
| 9 | 1 | x |
| 9 | 2 | y |
| 10 | 0 | z |

### Second Embodiment

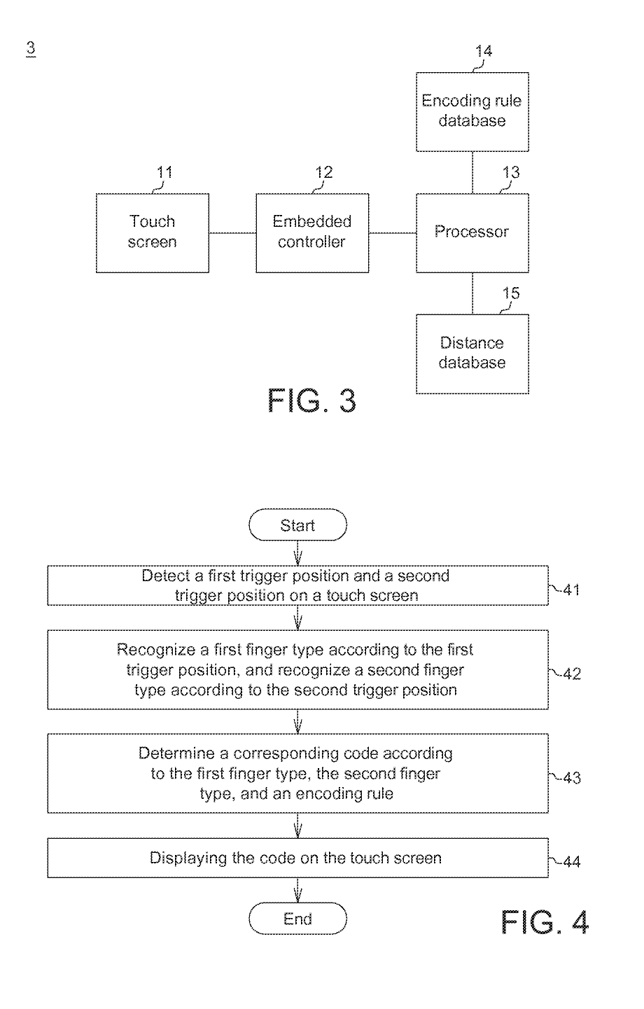

Referring to FIGS. 3 and 4, FIG. 3 illustrates a tablet computer 3 according to a second embodiment in a block diagram, and FIG. 4 illustrates an input method for the tablet computer according to the first embodiment in a flowchart. The second embodiment differs from the first embodiment in that the tablet computer 3 further includes a distance database 15 in addition to the touch screen 11, the embedded controller 12, the processor 13, and the encoding rule database 14. In the second embodiment, similar to the first embodiment, the processor 13 detects a touch state of the touch screen 11 through the embedded controller 12 when the touch screen 11 does not display a screen keyboard, wherein the touch state includes, for example, a first trigger position and a second trigger position on the touch screen 11.

The input method for the tablet computer 3 includes the following steps. First, in step 41, a first trigger position and a second trigger position on the touch screen 11 are detected. In step 42, a first finger type is recognized according to the first trigger position and a second finger type is recognized according to the second trigger position by the processor 13. The first finger type and the second finger type, for example, are thumb, index finger, middle finger, ring finger, or little finger. Specifically, for example, a first distance is determined according to the first touch position and an origin position, and a second distance is determined according to the second touch position and the origin position, by the processor 13. The processor 13 recognizes the first finger type according to the first distance and the distance database 15, and recognizes the second finger type according to the second distance and the distance database 15. After that, in step 43, a corresponding code is determined according to the first finger type, the second finger type, and an encoding rule by the processor 13. In step 44, the corresponding code is then displayed on the touch screen 11. Without the need of a screen keyboard displayed on the touch screen 11, the user can input data by way of combinations of the number of points of long touching and the number of tapping, thus enhancing the user's convenience of operation.

Referring to FIG. 3 and Table 3, Table 3 describes an encoding rule for the tablet computer 3. The encoding rule includes combinations of types of fingers triggering the touch screen 11. For example, when the thumb and the index finger of the user press the touch screen 11, the processor 13 detects the first trigger position and the second trigger position on the touch screen 11 through the embedded controller 12. The processor 13 detects that the first finger type is the thumb according to the first trigger position, and that the second finger type is the index finger according to the second trigger position. The processor 13 determines a corresponding code of “f” according to the finger types of the thumb and the index finger, and the encoding rule described in Table 3. In another example, when the index finger and the middle finger of the user press the touch screen 11, the processor 13 detects the first trigger position and the second trigger position on the touch screen 11 through the embedded controller 12. The processor 13 detects that the first finger type is the index finger according to the first trigger position, and that the second finger type is the middle finger according to the second trigger position. The processor 13 determines a corresponding code of “j” according to the finger types of the index finger and the middle finger, and the encoding rule described in Table 3.

TABLE 3

| Finger type | Code |
|---|---|
| Thumb | a |
| Index finger | b |
| Middle finger | c |
| Ring finger | d |
| Little finger | e |
| Thumb + index finger | f |
| Thumb + middle finger | g |
| Thumb + ring finger | h |
| Thumb + little finger | i |
| Index finger + middle finger | j |
| Index finger + ring finger | k |
| Index finger + little finger | l |
| Middle finger + ring finger | m |
| Middle finger + little finger | n |
| Ring finger + little finger | o |
| Thumb + index finger + middle finger | p |
| Thumb + index finger + ring finger | q |
| Thumb + index finger + little finger | r |
| Thumb + middle finger + ring finger | s |
| Thumb + middle finger + little finger | t |
| Thumb + ring finger + little finger | u |
| Index finger + middle finger + ring finger | v |
| Index finger + middle finger + little finger | w |
| Middle finger + ring finger + little finger | x |
| Thumb + index finger + middle finger + ring finger | y |
| Thumb + index finger + middle finger + little finger | z |

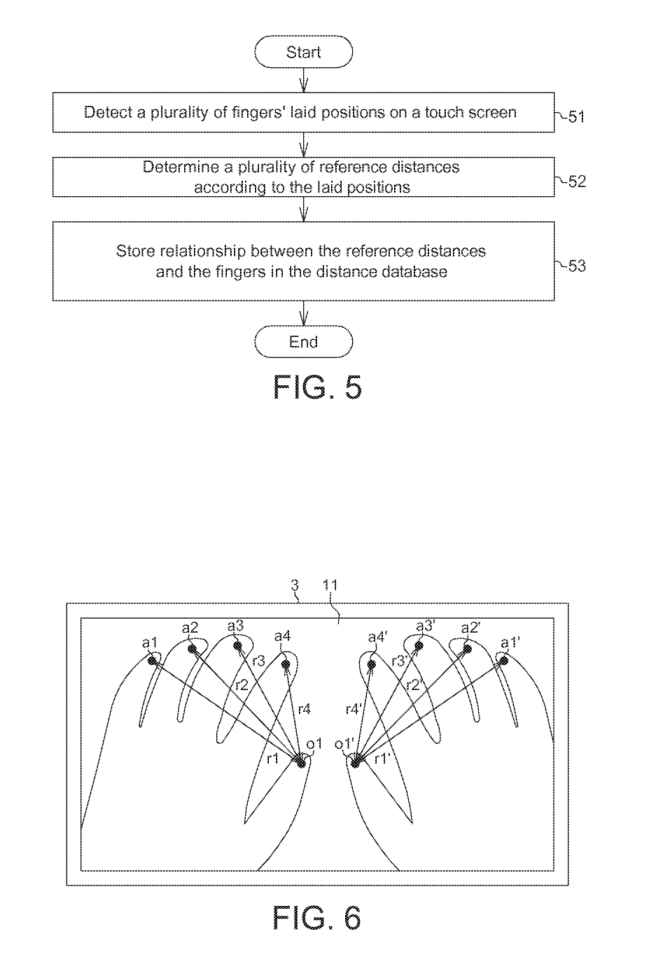

Referring to FIGS. 3, 5, and 6, FIG. 5 illustrates an initialization procedure for a tablet computer according to an embodiment in a flowchart, and FIG. 6 illustrates an example of fingers' laid positions on the touch screen. The above input method may further include an initialization procedure which includes the following steps. First, in step 51, detection of one or more laid positions of a number of fingers on the touch screen is performed. The laid positions of the thumb, the index finger, the middle finger, the ring finger, and the little finger of the left hand are laid positions o1, a4, a3, a2, and a1 respectively, and the laid positions of the thumb, the index finger, the middle finger, the ring finger, and the little finger of the right hand are laid positions o1′, a4′, a3′, a2′, and a1′ respectively.

In step 52, the processor 13 then determines reference distances r1, r2, r3, r4, r1′, r2′, r3′, and r4′ according to the laid positions a1, a2, a3, a4, o1, a1′, a2′, a3′, a4′, and o1′. The laid position o1, which is the position of the thumb, is defined as an origin position. Similarly, the laid position o1′, which is the position of the thumb, is defined as another origin position. The reference distance r1 is the distance from the laid positions a1 to o1; the reference distance r2 is the distance from the laid positions a2 to o1; the reference distance r3 is the distance from the laid positions a3 to o1; the reference distance r4 is the distance from the laid positions a4 to o1. Similarly, the reference distance r1′ is the distance from the laid positions a1′ to o1; the reference distance r2′ is the distance from the laid positions a2′ to o1; the reference distance r3′ is the distance from the laid positions a3′ to o1; the reference distance r4′ is the distance from the laid positions a4′ to o1.

After that, in step 53, the processor 13 stores the relationship between the reference distances r1, r2, r3, r4, r1′, r2′, r3′, and r4′ and the fingers in the distance database 15. Since the distances from the index finger, the middle finger, the ring finger, and the little finger to the thumb are basically fixed, a finger type can be determined by the reference distance.

The above described tablet computers and input methods facilitate the user to enter a code, for example, character(s), word(s), or symbol(s), correctly without the need to display a screen keyboard. In such a way, it can prevent the screen keyboard from occupying the display region, and enhance the accuracy for inputting data.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A tablet computer, comprising:
a touch screen;
an embedded controller;
a processor for detecting a touch state of the touch screen through the embedded controller, wherein after determining a corresponding code according to a touch state and an encoding rule, the processor displays the corresponding code on the touch screen; and
an encoding database for storing the encoding rule.

2. The tablet computer according to claim 1, wherein the touch state includes number of points of long touching and number of tapping, and the processor determines the corresponding code according to the number of points of long touching, the number of tapping, and the encoding rule.

3. The tablet computer according to claim 1, wherein the tablet computer detects the touch state after entering an input data mode.

4. The tablet computer according to claim 1, wherein the processor detects a touch state of the touch screen through the embedded controller when the touch screen does not display a screen keyboard.

5. The tablet computer according to claim 1, wherein the touch screen is used for setting the encoding rule.

6. The tablet computer according to claim 1, wherein the touch state includes a first trigger position and a second trigger position on the touch screen; the processor recognizes a first finger type according to the first trigger position; the processor recognizes a second finger type according to the second trigger position; and the processor determines the corresponding code according to the first finger type, the second finger type, and the encoding rule.

7. The tablet computer according to claim 6, further comprising a distance database, wherein the processor determines a first distance according to the first touch position and an origin position, and determines a second distance according to the second touch position and the origin position; and the processor recognizes the first finger type according to the first distance and the distance database, and recognizes the second finger type according to the second distance and the distance database.

8. The tablet computer according to claim 7, wherein the processor detects a plurality of laid positions of a plurality of fingers on the touch screen, determines a plurality of reference distances according to the laid positions, and stores relationship between the reference distances and the fingers in the distance database.

9. The tablet computer according to claim 8, wherein the reference distances include distances from a little finger, a ring finger, a middle finger, and an index finger to a thumb.

10. The tablet computer according to claim 8, wherein the laid positions include a thumb position, and the thumb position is defined as the origin position.

11. An input method for a tablet computer, the input method comprising:
detecting number of points of long touching and number of tapping on a touch screen of the tablet computer;
determining a corresponding code according to the number of points of long touching, the number of tapping, and an encoding rule; and
displaying the corresponding code on the touch screen.

12. The input method according to claim 11, further comprising:
setting the encoding rule.

13. The input method according to claim 11, wherein the step of detecting the number of points of long touching and the number of tapping is performed after the tablet computer enters an input data mode.

14. An input method for a tablet computer, the input method comprising:
detecting a first trigger position and a second trigger position on a touch screen of the tablet computer;
recognizing a first finger type according to the first trigger position, and recognizing a second finger type according to the second trigger position;
determining a corresponding code according to the first finger type, the second finger type, and an encoding rule; and
displaying the corresponding code on the touch screen.

15. The input method according to claim 14, further comprising:
determining a first distance according to the first touch position and an origin position, and determining a second distance according to the second touch position and the origin position; and
recognizing the first finger type according to the first distance and a distance database, and recognizing the second finger type according to the second distance and the distance database.

16. The input method according to claim 15, further comprising:
detecting a plurality of laid positions of a plurality of fingers on the touch screen;
determining a plurality of reference distances according to the laid positions; and
storing relationship between the reference distances and the fingers in the distance database.

17. The input method according to claim 16, wherein the reference distances include distances from a little finger, a ring finger, a middle finger, and an index finger, to a thumb.

18. The input method according to claim 17, wherein the laid positions include a thumb position, and the thumb position is defined as the origin position.

19. The input method according to claim 14, further comprising:
setting the encoding rule.

20. The input method according to claim 14, wherein the detecting step is performed after an input position is touched.
